(19) United States
(12) Patent Application Publication
(10) Pub. No.: US 2023/0338905 A1
(43) Pub. Date: Oct. 26, 2023

(54) POLYAMIDE REVERSE OSMOSIS MEMBRANE HAVING EXCELLENT DURABILITY AND ANTIFOULING PROPERTIES, AND METHOD FOR MANUFACTURING SAME

(71) Applicant: Toray Advanced Materials Korea Inc., Gyeongsangbuk-do (KR)

(72) Inventors: Cheong Hee KIM, Gyeongsangbuk-do (KR); Jong Hwa LEE, Gyeongsangbuk-do (KR); Ja Young KOO, Gyeongsangbuk-do (KR)

(73) Assignee: Toray Advanced Materials Korea Inc., Gyeongsangbuk-do (KR)

(21) Appl. No.: 18/023,656

(22) PCT Filed: Oct. 15, 2021
(86) PCT No.: PCT/KR2021/014310

§ 371 Date: Feb. 27, 2023

(30) Foreign Application Priority Data
Dec. 10, 2020 (KR) 10-2020-0172191

(51) Int. Cl. B01D 71/56; B01D 69/02; B01D 61/02; B01D 65/08; B01D 69/10; B01D 67/00

(52) U.S. Cl. CPC B01D 71/56; B01D 69/02; B01D 61/025; B01D 65/08; B01D 69/10; B01D 67/0006; B01D 67/0088; B01D 67/0093; B01D 2325/24; B01D 2325/30; B01D 2323/36; B01D 2323/30

(57) ABSTRACT

The present invention relates to a polyamide reverse osmosis membrane including a porous support; a polyamide layer which is formed on at least one surface of the porous support; a fouling resistant layer which is formed on the polyamide layer; and a protective coating layer which is formed on the fouling resistant layer and linked by cross-linking with the fouling resistant layer, and more specifically to a polyamide reverse osmosis membrane having excellent durability and antifouling properties in which antifouling properties are improved, but there is no decrease in flow rate and salt removal rate, and there is little decrease in physical properties due to fouling and little change over time due to a preservation solution, and chlorine durability is also excellent.

### TECHNICAL FIELD

The present invention relates to a polyamide reverse osmosis membrane having excellent durability and antifouling properties and a method for manufacturing the same.

### BACKGROUND ART

Osmosis is a phenomenon in which the solvent moves from a solution with a low solute concentration to a solution with a high solute concentration between two solutions that are separated by a semi-permeable membrane through a separation membrane, and in this case, the pressure acting on the side of a solution with a high concentration of solute due to the movement of the solvent is called osmotic pressure. Conversely, if an external pressure higher than the osmotic pressure is applied, the solvent moves toward the side of a solution with a lower solute concentration, and this phenomenon is called reverse osmosis.

The use of a conventional reverse osmosis membrane is a desalination process of brackish water or seawater, and this desalination process provides a large amount of fresh water or pure water suitable for industry, agriculture or household use. The desalination process of brackish water or seawater by using a reverse osmosis membrane is a process of literally filtering salts and other dissolved ions or molecules from salt water, and by passing salt water through a reverse osmosis membrane and pressurizing the same, purified water passes through a separation membrane while salts and other dissolved ions or molecules do not pass through the separation membrane.

Separation membranes used in the membrane filtration process are subject to phenomena such as organic fouling, inorganic fouling, particle fouling and bio-fouling depending on their use, and since their performance continuously deteriorates, the situation is that research on a reverse osmosis membrane having excellent durability without deterioration in flow rate and salt removal rate is required.

For example. Korean Registered Patent No. 10-1230843 is an invention related to a reverse osmosis membrane, which is characterized in that a porous support and a polyamide layer are formed, and a coating layer which is capable of improving the antifouling performance is additionally formed on the polyamide layer. However, although the above invention has improved fouling resistance, it has problems such as poor fouling or poor durability in chlorine and preservative solutions.

### DISCLOSURE

### Technical Problem

The present invention is directed to providing a polyamide reverse osmosis membrane having excellent durability and antifouling properties in which the antifouling properties are improved, the flow rate and the salt removal rate are not lowered, the deterioration of performance by fouling does not occur, and there is no decrease in physical properties due to exposure to chlorine and immersion in a preservation solution, by sequentially forming a fouling resistant layer and a protective coating layer which is linked by cross-linking with the fouling resistant layer on the surface of a polyamide layer, respectively, and a method for manufacturing the same.

### Technical Solution

The polyamide reverse osmosis membrane having excellent durability and antifouling properties according to the present invention which has been devised to solve the above problems may include a porous support; a polymer support layer which is formed on at least one surface of the porous support; a polyamide layer which is formed on the polymer support layer; a fouling resistant layer which is formed on the polyamide layer; and a protective coating layer which is formed by cross-linking with a fouling resistant layer on the fouling resistant layer.

In a preferred exemplary embodiment of the present invention, the fouling resistant layer may include a reaction product obtained by reacting a primary amine compound including at least one of a hydroxy group and an alkoxy group; and a polyfunctional acid halide compound.

In a preferred exemplary embodiment of the present invention, the protective coating layer may include a cross-linked product of polyvinyl alcohol and glutaraldehyde.

In a preferred exemplary embodiment of the present invention, the polyamide layer may include a reaction product obtained by reacting an amine compound and a polyfunctional acid halide compound.

In a preferred exemplary embodiment of the present invention, when the reverse osmosis membrane is operated for 1 hour at a temperature of 25° C. and a pressure of 150 psi under the conditions of an aqueous solution including 1,500 ppm of sodium chloride (NaCl), the flow rate may be 18.0 gfd or more.

In a preferred exemplary embodiment of the present invention, when the flow rate is measured after the reverse osmosis membrane is circulated in raw water including 1,500 ppm of sodium chloride (NaCl) by further adding 50 ppm of dry milk, which is an organic contaminant, for 2 hours at a pressure of 150 psi to contaminate the membrane, the ratio of the reduced flow rate compared to the initial flow rate may be less than 20%.

In a preferred exemplary embodiment of the present invention, the reverse osmosis membrane may have a salt removal reduction rate of less than 13.0% after exposure to chlorine as measured by Relationship Formula 1 below:

Salt removal reduction rate (%)=|Initial salt removal rate (%)−Salt removal rate after exposure to chlorine (%)|/(Initial salt removal rate (%))×100%, [Relationship Formula 1]

wherein in Relationship Formula 1 above, the ‘initial salt removal rate’ refers to the salt removal rate measured by operating the polyamide reverse osmosis membrane at a pressure of 150 psi under the conditions of raw water including NaCl at a concentration of 1,500 ppm, and the ‘salt removal rate after exposure to chlorine’ refers to the salt removal rate measured when the polyamide osmosis membrane is operated for 6 hours under the conditions of an aqueous solution including 1,500 ppm NaCl and 1,000 ppm NaOCl.

As another object of the present invention, the method for manufacturing a polyamide reverse osmosis membrane having excellent durability and antifouling properties may include the steps of forming a polymer support layer by applying and drying a polymer solution on the surface of a porous support; forming a polyamide layer on the surface of the polymer support layer; forming a fouling resistant layer by coating an antifouling coating agent on the surface of the polyamide layer; and forming a protective coating layer by coating a protective coating solution on the surface of the fouling resistant layer.

In a preferred exemplary embodiment of the present invention, the polymer solution may include a polymer compound and a solvent, and wherein the polymer compound may include at least one selected from polysulfone-based polymers, polyethersulfone-based polymers, polyamide-based polymers, polyimide-based polymers, polyester-based polymers, olefin-based polymers, polyvinylidene fluoride and polyacrylonitrile.

In a preferred exemplary embodiment of the present invention, the antifouling coating agent may include 0.001 to 10 wt. % of a primary amine compound including at least one of a hydroxy group and an alkoxy group; and a residual amount of solvent.

In a preferred exemplary embodiment of the present invention, the protective coating layer may include a cross-linked product in which polyvinyl alcohol and glutaraldehyde are cross-linked at a weight ratio of 1:0.3 to 1:1.5.

### Advantageous Effects

Through the present invention, it is possible to provide a polyamide reverse osmosis membrane having excellent durability and antifouling properties in which the physical properties are excellent even in the case of membrane contamination and the deterioration of durability does not occur after exposure to chlorine and immersion in a preservation solution, and a method for manufacturing the same.

### MODES OF THE INVENTION

Hereinafter, the present invention will be described in more detail through a method for manufacturing a reverse osmosis membrane having excellent durability and antifouling properties according to the present invention.

The method for manufacturing a reverse osmosis membrane may include step 1 of forming a polymer support layer by applying and drying a polymer solution on the surface of a porous support; step 2 of forming a polyamide layer on the surface of the polymer support layer; step 3 of forming a fouling resistant layer by coating an antifouling coating agent on the surface of the polyamide layer; and step 4 of forming a protective coating layer by coating a protective coating solution on the surface of the fouling resistant layer.

First, the porous support of step 1 may include a synthetic fiber or a natural fiber, and a preferred example of the synthetic fiber may include at least one selected from polyester fibers, polypropylene fibers, nylon fibers and polyethylene fibers, and a preferred example of the natural fiber may include cellulose-based fibers.

In addition, the porous support may have a thickness (width) of 20 to 200 μm, and preferably, 50 to 150 μm.

Meanwhile, the polymer solution may include a polymer compound and a residual amount of solvent, and the polymer compound may be included in an amount of 5 to 40 wt. %, and preferably, 7 to 35 wt. %, based on the total weight of the polymer solution.

In addition, the polymer compound may include at least one selected from polysulfone-based polymers, polyethersulfone-based polymers, polyamide-based polymers, polyimide-based polymers, polyester-based polymers, olefin-based polymers, polyvinylidene fluoride and polyacrylonitrile, and preferably, it may include a polysulfone-based polymer.

In addition, the solvent included in the polymer solution may be used without particular limitation as long as it can uniformly and completely dissolve the polymer without precipitate, and preferably, it may include at least one selected from N-methyl-2-pyrrolidone (NMP), dimethylformamide (DMF), dimethyl sulfoxide (DMSO) and dimethylacetamide (DMAc).

Meanwhile, the coating of step 1 may be performed such that the thickness of the polymer support layer is 30 to 300 μm, and preferably, 80 to 250 μm, and if the thickness of the polymer support layer is less than 30 μm, there may be problems of decreases in flow rate and durability due to compaction, and if the thickness is more than 300 μm, the problem of a decrease in flow rate may occur as the flow path becomes longer.

Next, the polyamide layer of step 2 may be formed by sequentially coating an amine solution and a polyfunctional acid halogen solution on the porous support.

Specifically, the coating of the amine solution may be performed by spraying or immersing the amine solution on the porous support, on which the polymer support layer is formed, for 0.1 to 10 minutes, and preferably, it may be performed for 0.5 to 1 minute.

In this case, the amine solution may include an amine compound and a residual amount of the solvent, and the amine compound may be included in an amount of 0.1 to 20.0 wt. %, and preferably, 0.1 to 8.0 wt. %, based on the total weight of the amine solution, and more preferably, it may be included in an amount of 0.1 to 5.0 wt. %.

In addition, the amine compound is a material having 1 to 3 amine functional groups per monomer, and it may include at least one selected from a polyamine including a primary amine or a secondary amine; aromatic primary diamine as a substituent; aliphatic primary diamine; cycloaliphatic primary diamine; cycloaliphatic secondary amine; and aromatic secondary amine, and preferably, it may include at least one selected from diamine meta-phenylenediamine, para-phenylenediamine, ortho-phenylenediamine, cyclohexenediamine and piperazine, and more preferably, it may include at least one selected from meta-phenylenediamine, para-phenylenediamine and ortho-phenylenediamine, and still more preferably, it may include meta-phenylenediamine (m-phenylenediamine).

In addition, the solvent of the amine solution may be used without particular limitation as long as it can uniformly dissolve the amine compound, and preferably, it may include water.

Next, the excess amine solution present on the surface of the polymer support layer is removed by rolling, sponge, air knife or other suitable method, and then, after the polyfunctional acid halogen solution is sprayed or immersed on the surface of the porous support coated with the amine solution to perform contact and polymerization reactions, a polyamide layer may be formed by drying.

In this case, the treatment of the polyfunctional acid halogen solution may be performed for 5 seconds to 3 minutes, and preferably, 5 seconds to 2 minutes, and the drying may be performed for 10 seconds to 5 minutes, and preferably, 15 seconds to 4 minutes in a drying manner.

In addition, the polyfunctional acid halogen solution may include a polyfunctional acid halogen compound and a residual amount of solvent, and the polyfunctional acid halogen compound may be included in an amount of 0.005 to 5.0 wt. %, and preferably, 0.01 wt. % to 2.0 wt. %, based on the total weight of the solution, and more preferably, it may be included in an amount of 0.05 to 0.3 wt. %.

In addition, the polyfunctional acid halide compound may include at least one selected from polyfunctional acyl halide, polyfunctional sulfonyl halide and polyfunctional isocyanate, and preferably, it may include trimesoyl chloride, isophthaloyl chloride, terephthaloyl chloride, 1,3,5-cyclohexanetricarbonyl chloride and 1,2,3,4-cyclohexanetetracarbonyl chloride, and more preferably, it may include trimesoyl chloride (TMC).

In addition, the solvent of the polyfunctional acid halide solution is a water-immiscible solvent, does not participate in interfacial polymerization, does not chemically bond with the polyfunctional acid halogen compound, and does not damage the support, and it is preferable to use a mixture of structural isomers of n-alkane having 5 to 12 carbon atoms and saturated or unsaturated hydrocarbon having 5 to 12 carbon atoms or cyclic hydrocarbon having 5 to 7 carbon atoms.

The polyamide layer formed through steps 1 to 2 may have a thickness of 0.1 to 1.0 μm, and preferably, 0.3 to 0.8 μm, and if the thickness of the polyamide layer is more than 1.0 μm, the thickness of the selection layer becomes too thick, which may cause a problem in that the flow rate decreases.

Next, the coating of the antifouling coating agent in step 3 may be performed by one method selected from spray method, T-die method, dipping and cloth coating method, and it may be performed on the surface of the polyamide layer for 5 seconds to 10 minutes, and preferably, for 10 seconds to 5 minutes.

In addition, the antifouling coating agent may include a primary amine compound including at least one of a hydroxy group and an alkoxy group and a residual amount of solvent, and the primary amine compound may be included in an amount of 0.001 to 10 wt. % based on the total weight of the antifouling coating agent, and preferably, it may be included in an amount of 0.001 to 8 wt. %, and more preferably, it may be included in an amount of 0.001 to 5 wt. %.

In this case, the solvent of the antifouling coating agent may include water, alcohol or a mixed solvent thereof.

If the primary amine compound is included in an amount of less than 0.001 wt. %, the effect of improving fouling resistance may be reduced or minor problems may occur, and if it is included in an amount of more than 10 wt. %, there may be a problem in that the permeate flow rate rapidly decreases.

In addition, the primary amine compound may include a primary amine including at least one of a hydroxyl group and an alkoxy group, and preferably, the primary amine compound may include at least one selected from R—NH₂, HOR—NH₂, H₃CO—RNH₂ and (OCH₃)₂R—NH₂, wherein R may be a straight-chain alkylene group having 1 to 6 carbon atoms, and preferably, a straight-chain alkylene group having 1 to 5 carbon atoms.

In addition, a preferred example of the primary amine compound may be at least one selected from ethanol amine (ETA) and aminoacetaldehyde dimethyl acetal (AADA), and a more preferred example may be ethanol amine (ETA).

In addition, since the primary amine compound includes at least one selected from a hydroxy group and an alkoxy group in the structure, the hydroxy group and the alkoxy group may serve to cross-link between the fouling resistant layer and the protective coating layer, thereby improving the durability of a reverse osmosis membrane.

Next, the protective coating solution of step 4 may be continuously performed after coating with the antifouling coating agent, and it may be performed for 10 seconds to 10 minutes, and preferably, for 15 seconds to 5 minutes.

In addition, the coating of step 4 may be performed at 25 to 110° C., and preferably, at 50 to 100° C. If it is performed at less than 25° C., there may be a problem in that the drying time takes a long time, and if it is performed at a temperature of more than 110° C., thermal deformation may occur in the separator, thereby causing a problem of deterioration of physical properties.

In this case, the protective coating solution may include polyvinyl alcohol (PVA), glutaric acid, toluene sulfonic acid (TSA) and a solvent.

In addition, the glutaraldehyde may serve as a cross-linking agent for cross-linking between polyvinyl alcohol.

Meanwhile, the toluenesulfonic acid may serve as a catalyst for cross-linking between the polyvinyl alcohol and glutaraldehyde, and the toluenesulfonic acid may be included in an amount of 0.005 to 0.2 wt. % based on the total weight of the solution, and preferably, it may be included in an amount of 0.007 to 0.15 wt. %. If the toluenesulfonic acid is included in an amount of less than 0.005 wt. %, the protective coating film may not be properly formed due to insufficient cross-linking, and as a result, there may be a problem in that the durability of the reverse osmosis membrane is deteriorated, and if it is included in an amount of more than 0.2 wt. %, the amount of acid becomes excessive such that there may be a problem in that the removal rate of a separation membrane decreases.

In addition, the sum of the contents of polyvinyl alcohol and glutaraldehyde may be included in an amount of 0.05 to 2.0 wt. %, and preferably, it may be included in an amount of 0.05 to 1.0 wt. %, based on the total weight of the protective coating solution. If the sum of the contents of polyvinyl alcohol and glutaraldehyde is included in an amount of less than 0.5 wt. %, the protective coating film is not properly formed such that there may be a problem of the deterioration of durability of the reverse osmosis membrane, and if it is included in an amount of more than 2.0 wt. %, there may be a problem in that the flow rate is reduced.

Meanwhile, the solvent of the protective coating solution may be the remaining amount of the total weight of the protective coating solution excluding the polyvinyl alcohol, glutaraldehyde and toluenesulfonic acid, and it may include water, alcohol or a mixed solvent thereof, and preferably, it may include water.

Meanwhile, the protective coating layer may include a cross-linked product obtained by cross-linking the polyvinyl alcohol and glutaraldehyde at a weight ratio of 1:0.3 to 1:1.5, and preferably, at a weight ratio of 1:0.5 to 1:1.3. If the glutaraldehyde is included at a weight ratio of less than 0.3, durability may deteriorate due to insufficient cross-linking, and if it is included at a weight ratio of more than 1.5, there may be problems in that the concentration of the protective coating solution increases and the permeation flow rate decreases.

Through the reaction of the above four steps, the polyvinyl alcohol and glutaraldehyde may be cross-linked to form a protective coating layer, and with the formation of the protective coating layer, the hydroxy group and the alkoxy group of the fouling resistant layer may be cross-linked and connected to the protective coating layer.

The reverse osmosis membrane having excellent durability and antifouling properties manufactured through the above manufacturing method may include a porous support; a polymer support layer which is formed on at least one surface of the porous support; a polyamide layer which is formed on the polymer support layer; a fouling resistant layer which is formed on the polyamide layer; and a protective coating layer which is formed by cross-linking with a fouling resistant layer on the fouling resistant layer.

Meanwhile, the polymer support layer may be formed on at least one surface of the porous support layer, and preferably, it may be formed on one surface of the porous support layer.

In addition, the protective coating layer may include a cross-linked product of polyvinyl alcohol and glutaraldehyde.

In addition, the polyamide layer may include a reaction product obtained by reacting an amine compound and a polyfunctional acid halide compound.

Meanwhile, in the conditions of an aqueous solution including 1,500 ppm of sodium chloride (NaCl), the flow rate and salt removal rate of the reverse osmosis membrane may be measured after operating for 1 hour at a temperature of 25° C. and a pressure of 150 psi.

In this case, the flow rate may be 18.0 gfd or more, preferably, 20.0 to 28.0 gfd, and more preferably, 22.0 to 26.0 gfd.

In addition, the salt removal rate may be measured through Relationship Formula 2 below by measuring the ion conductivity value (TDS: Total Dissolved Solids), and the salt removal rate may be 99.0% or more, and preferably, 99.0 to 100.0%.

Salt removal rate (%)={1−(Conductivity value of produced water/Conductivity value of raw water)}×100(%) [Relationship Formula 2]

Meanwhile, the flow rate reduction ratio after fouling of the reverse osmosis membrane may be less than 20%, preferably, 11.0 to 18.0%, and more preferably, 12.0 to 17.0%. In this case, the flow rate reduction ratio after contamination of the reverse osmosis membrane is to measure a ratio of flow rate reduced compared to the initial flow rate, when the flow rate is measured after further adding 50 ppm of dry milk, which is an organic contaminant, in raw water including 1,500 ppm of sodium chloride (NaCl) to circulate raw water at a pressure of 150 psi for 2 hours.

Meanwhile, the reverse osmosis membrane may have a salt removal reduction rate after exposure to chlorine as measured by Relationship Formula 1 below of less than 13.0%, preferably, 2.0 to 12.5%, and more preferably, 2.5 to 9.0%.

Salt removal reduction rate (%)=|Initial salt removal rate (%)−Salt removal rate after exposure to chlorine (%)|/(Initial salt removal rate (%))×100%, [Relationship Formula 1]

In Relationship Formula 1 above, the ‘initial salt removal rate’ refers to the salt removal rate measured by operating the polyamide reverse osmosis membrane at a pressure of 150 psi under the conditions of raw water including NaCl at a concentration of 1,500 ppm, and the ‘salt removal rate after exposure to chlorine’ refers to the salt removal rate measured when the polyamide osmosis membrane is operated for 6 hours under the conditions of an aqueous solution including 1,500 ppm NaCl and 1,000 ppm NaOCl.

In addition, the conventional reverse osmosis membrane had a problem in that the salt removal rate rapidly decreases when exposed to chlorine, but the reverse osmosis membrane of the present invention has advantages in that the fouling resistant layer and the protective coating layer are cross-linked, and the polyvinyl alcohol of the protective coating layer is cross-linked such that the reduction ratio of the salt removal rate does not decrease even after exposure to chlorine.

Meanwhile, the reverse osmosis membrane has excellent durability because the flow rate does not decrease even after being immersed in a preservation solution, and the flow rate reduction ratio after immersion in a preservation solution as measured by Relationship Formula 3 below may be 1.4% or less, preferably, 0.01 to 1.0%, and more preferably, 0.1 to 0.9%.

Flow rate reduction ratio (%)={Initial flow rate gfd)−Flow rate after immersion in preservation solution (gfd)}/{Initial flow rate (gfd)}×100(%) [Relationship Formula 3]

In Relationship Formula 3 above, the ‘flow rate after immersion in preservation solution’ means the flow rate after immersing for 5 days in a solution (preservation solution) including 1 wt. % of sodium bicarbonate, and the ‘initial flow rate’ means the flow rate before immersion in a preservation solution.

Although the present invention will be described in more detail through the following examples, the following examples are not intended to limit the scope of the present invention, which should be interpreted to aid understanding of the present invention.

### EXAMPLE

### Example 1: Manufacture of Polyamide Reverse Osmosis Membrane

A porous polysulfone support having a thickness of 140 μm including polyethylene terephthalate (PET) nonwoven fabric was prepared.

Next, a polymer solution including a remaining amount of N-methyl-2-pyrrolidone (NMP) in 18 wt. % and 100 wt. % of polysulfone-based polymer (polymer compound) was applied and dried on the surface of the porous polysulfone support to form a polymer support layer on the surface of the porous polysulfone support.

Next, the porous support on which the polymer support layer was formed was immersed in an aqueous solution including 2 wt. % of meta-phenylenediamine (m-phenylenediamine, MPD, amine compound) to coat the porous support, and then, the excess aqueous solution was removed.

Next, after immersing for 60 seconds in a polyfunctional acid halogen solution including 0.1 wt. % of trimesoyl chloride (TMC), which is a polyfunctional acid halogen compound, and a remaining amount of Isopar solvent, it was dried in the air for 1 minute to form a polyamide layer, and then, Laminate 1 in which a porous support—a polymer support layer—a polyamide layer were sequentially formed was manufactured.

Next, an antifouling coating agent was coated on the surface of the polyamide layer of Laminate 1 for 20 seconds by the spray coating method to form a fouling resistant layer, and an excess solution on the surface of the fouling resistant layer was removed to manufacture Laminate 2 in which a porous support—a polymer support layer—a polyamide layer—a fouling resistant layer were sequentially formed.

In this case, the antifouling coating agent includes 0.1 wt. % of ethanolamine (ETA) as a primary amine compound and a remaining amount of water (H₂O), and the ethanolamine is a straight-chain alkylene group in which R in HOR—NH₂ has 2 carbon atoms.

Next, after coating a protecting coating liquid on the surface of the fouling resistant layer of Laminate 2 by the spray coating method for 20 seconds, the excess solution was removed, and then, it was dried at 80° C. for 1 minute and stored in the air at room temperature (25 to 28° C.) for 1 day to manufacture a polyamide reverse osmosis membrane formed with a protecting coating layer which was cross-linked with the fouling resistant layer of Laminate 2.

In this case, the protective coating solution included 0.5 wt. % of a cross-linking component including polyvinyl alcohol and glutaraldehyde, 0.1 wt. % of a toluene sulfonic acid (TSA) catalyst and a remaining amount of water, and the protective coating layer included a cross-linked product obtained by cross-linking polyvinyl alcohol (PVA) and glutaraldehyde GA) at a weight ratio of 1:1.1.

Next, Laminate 2 which was coated with the protective coating solution was dried at 80° C. for 1 minute, and stored in the air at room temperature (25 to 28° C.) for 1 day to manufacture a polyamide reverse osmosis membrane.

### Examples 2 to 5: Manufacture of Polyamide Reverse Osmosis Membrane

These were manufactured in the same manner as in Example 1, except that the weight percentage of the primary amine compound based on the total weight of the antifouling coating agent or the weight ratio of polyvinyl alcohol (PVA) and glutaraldehyde (Glutaraldehyde, GA) in the protective coating solution was adjusted as shown in Tables 1 to 2 below to carry out Examples 2 to 5.

### Example 6: Manufacture of Polyamide Reverse Osmosis Membrane

It was manufactured in the same manner as in Example 1, except that Example 6 was carried out by using aminoacetaldehyde dimethyl acetal (AADA) instead of ethanol amine (ETA) as the primary amine compound.

In this case, the AADA is a case where R in (OCH₃)₂RNH₂ is a straight-chain alkylene group having 2 carbon atoms.

### Comparative Example 1: Manufacture of Polyamide Reverse Osmosis Membrane

A porous polysulfone support having a thickness of 140 μm including polyethylene terephthalate (PET) non-woven fabric was prepared.

Next, a polymer solution including 18 wt. % of a polysulfone-based polymer (polymer compound) and a remaining amount of N-methyl-2-pyrrolidone (NMP) was applied on the surface of the porous polysulfone support to form a polymer support layer on the surface of the porous polysulfone support.

Next, the porous support on which the polymer support layer was formed was immersed in an aqueous solution including 2 wt. % of meta-phenylenediamine (m-phenylenediamine, MPD, amine compound) to coat the porous support, and then, the excess aqueous solution was removed.

Next, after immersing in a polyfunctional acid halogen solution including 0.1 wt. % of trimesoyl chloride (TMC), which is a polyfunctional acid halogen compound, and a remaining amount of Isopar solvent for 60 seconds, a polyamide layer was formed by drying in the air for a 1 minute to manufacture Laminate 1 in which a porous support—a polymer support layer—a polyamide layer were sequentially.

Next, an antifouling coating agent was coated on the surface of the polyamide layer of the laminate for 20 seconds by the spray coating method to form a fouling resistant layer, and an excess solution on the surface of the fouling resistant layer was removed to manufacture Laminate 2 in which a porous support—a polymer support layer—a polyamide layer—a fouling resistant layer were sequentially formed.

In this case, the antifouling coating agent included 0.1 wt. % of ethanol amine (ETA) as the primary amine compound and a remaining amount of water (H₂O), and the ethanolamine was a straight-chain alkylene group in which R in HOR—NH₂ has 2 carbon atoms.

Next, Laminate 2 was dried at 80° C. for 1 minute and stored in the air at room temperature for 1 day to manufacture a polyamide reverse osmosis membrane.

### Comparative Example 2: Manufacture of Polyamide Reverse Osmosis Membrane

A porous polysulfone support having a thickness of 140 μm including polyethylene terephthalate (PET) non-woven fabric was prepared.

Next, a polymer solution including 18 wt. % of a polysulfone-based polymer (polymer compound) and a remaining amount of N-methyl-2-pyrrolidone (NMP) was applied on the surface of the porous polysulfone support to form a polymer support layer on the surface of the porous polysulfone support.

Next, the porous support on which the polymer support layer was formed was immersed in an aqueous solution including 2 wt. % of meta-phenylenediamine (m-phenylenediamine, MPD, amine compound) to coat the porous support, and then, the excess aqueous solution was removed.

Next, after immersing in a polyfunctional acid halogen solution including 0.1 wt. % of trimesoyl chloride (TMC), which is a polyfunctional acid halogen compound, and the remaining amount of Isopar solvent for 60 seconds, a polyamide layer was formed by drying in the air for 1 minute to manufacture Laminate 1 in which a porous support—a polymer support layer—a polyamide layer were sequentially formed.

Next, an antifouling coating agent was coated on the surface of the polyamide layer of Laminate 1 for 20 seconds by the spray coating method to form a fouling resistant layer, and an excess solution on the surface of the contamination resistant layer was removed to manufacture Laminate 2 in which a porous support—a polymer support layer—a polyamide layer—a fouling-resistant layer were sequentially formed.

In this case, the antifouling coating agent included 0.1 wt. % of methyl amine and a remaining amount of water (H₂O).

Next, Laminate 2 was dried at 80° C. for 1 minute and stored in the air at room temperature for 1 day to manufacture a polyamide reverse osmosis membrane.

### Comparative Example 3: Manufacture of Polyamide Reverse Osmosis Membrane

A polyamide reverse osmosis membrane was manufactured in the same manner as in Example 1, except that Comparative Example 3 was carried out by using methyl amine instead of ethanol amine (ETA) as the antifouling coating agent.

### Comparative Examples 4 to 6: Manufacture of Polyamide Reverse Osmosis Membrane

A polyamide reverse osmosis membrane was manufactured in the same manner as in Example 1, except the weight % of the primary amine compound based on the total weight of the fouling-resistant coating or the weight ratio of polyvinyl alcohol (PVA) and glutaraldehyde (Glutaraldehyde, GA) in the protective coating solution was adjusted as shown in Table 3 below to carry out Comparative Examples 4 to 6.

### Experimental Example 1: Measurement of Physical Properties of Polyamide Reverse Osmosis Membranes

In order to evaluate the physical properties of the polyamide reverse osmosis membranes manufactured in Examples 1 to 6 and Comparative Examples 1 to 6, each of the reverse osmosis membranes was subjected to the conditions of an aqueous solution including 1,500 ppm of sodium chloride (NaCl) at a temperature of 25° C. and a pressure of 150 psi to measure the flow rate and salt removal rate, and the results are shown in Tables 1 to 3 below.

In this case, the salt removal rate was measured through Relationship Formula 2 below by measuring the ion conductivity value (TDS: Total Dissolved Solids).

Salt removal rate (%)={1−(Conductivity value of produced water/Conductivity value of raw water)}×100(%) [Relationship Formula 2]

### Experimental Example 2: Evaluation of Fouling Resistance Performance of Polyamide Reverse Osmosis Membranes

In order to evaluate the fouling resistance performance of the polyamide reverse osmosis membranes manufactured in Examples 1 to 6 and Comparative Examples 1 to 6, 50 ppm of dry milk, which is an organic contaminant, was further added to raw water including 1,500 ppm of sodium chloride (NaCl) to circulate the raw water for 2 hours at a pressure of 150 psi to contaminate the membrane, and the ratio of the reduced flow rate compared to the initial flow rate was measured, and the results are shown in Tables 1 to 3 below. In addition, it was evaluated that the separation membrane had excellent fouling resistant performance as the flow rate reduction ratio was lower after contamination.

### Experimental Example 3: Evaluation of Durability of Polyamide Reverse Osmosis Membranes

In order to evaluate the durability (physical properties of the preservative solution over time) of the polyamide reverse osmosis membranes manufactured in Examples 1 to 6 and Comparative Examples 1 to 6, the flow rate reduction ratio was measured through Relationship Formula 3 below, and the results are shown in Tables 1 to 3 below. In addition, it was evaluated that the durability was excellent as the flow rate reduction ratio was lower during long-term storage of the preservation solution.

Flow rate reduction ratio (%)={Initial flow rate (gfd)−Flow rate after immersion in preservation solution (gfd)}/{Initial flow rate (gfd)}×100(%) [Relationship Formula 3]

In Relationship Formula 3 above, the ‘flow rate after immersion in preservation solution’ means the flow rate after immersing for 5 days in a solution (preservation solution) including 1 wt. % of sodium bicarbonate, and the ‘initial flow rate’ means the flow rate before immersion in a preservation solution.

### Experimental Example 4: Evaluation of Durability of Polyamide Reverse Osmosis Membranes

In order to evaluate the durability (salt removal reduction rate after chlorine exposure) of the polyamide reverse osmosis membranes manufactured in Examples 1 to 6 and Comparative Examples 1 to 6, the salt removal reduction rate was measured through Relationship Formula 1, and the results are shown in Tables 1 to 3 below. In addition, it was evaluated that the separation membrane had excellent durability against chlorine as the salt removal reduction rate was low.

Salt removal reduction rate (%)=|Initial salt removal rate (%)−Salt removal rate after exposure to chlorine (%)|/(Initial salt removal rate (%))×100%, [Relationship Formula 1]

In Relationship Formula 1 above, the ‘initial salt removal rate’ refers to the salt removal rate measured by operating the polyamide reverse osmosis membrane at a pressure of 150 psi under the conditions of raw water including NaCl at a concentration of 1,500 ppm, and the ‘salt removal rate after exposure to chlorine’ refers to the salt removal rate measured when the polyamide osmosis membrane is operated for 6 hours under the conditions of an aqueous solution including 1,500 ppm NaCl and 1,000 ppm NaOCl.

TABLE 1

| Classification | | | | Example 1 | Example 2 | Example 3 | Example 4 |
|---|---|---|---|---|---|---|---|
| Manufacturing | Antifouling | Primary amine | Type | ETA | ETA | ETA | ETA |
| method | coating agent | compound | Wt. % | 0.1 | 0.001 | 10.0 | 0.1 |

| | | | | | |
|---|---|---|---|---|---|
| | Water (wt. %) | 99.9 | 99.999 | 90.0 | 99.9 |
| Protective | Weight ratio | 1:1.1 | 1:1.1 | 1:1.1 | 1:0.3 |
| coating solution | of PVA:GA | | | | |

| | | | | | |
|---|---|---|---|---|---|
| Reverse | Flow rate (gfd) | 23.0 | 23.3 | 20.2 | 24.6 |
| osmosis | Salt removal rate (%) | 99.54 | 99.62 | 99.18 | 99.66 |
| membrane | Flow rate reduction ratio after | 15.0 | 16.8 | 12.5 | 15.9 |
| | contamination (%) | | | | |
| | Flow rate reduction ratio after | 0.40 | 0.46 | 0.30 | 0.5 |
| | immersion in preservation solution (%) | | | | |
| | Salt removal reduction rate after | 6.35 | 6.85 | 4.26 | 7.56 |
| | exposure to chlorine (%) | | | | |

TABLE 2

| | | | | | | Comparative | Comparative |
|---|---|---|---|---|---|---|---|
| Classification | | | | Example 5 | Example 6 | Example 1 | Example 2 |
| Manufacturing | Antifouling | Primary amine | Type | ETA | AADA | ETA | Methyl amine |
| method | coating agent | compound | Wt. % | 0.1 | 0.1 | 0.1 | 0.1 |

| | | | | | |
|---|---|---|---|---|---|
| | Water (wt. %) | 99.9 | 99.9 | 99.9 | 99.9 |
| Protective | Weight ratio | 1:1.5 | 1:1.1 | — | — |
| coating solution | of PVA:GA | | | | |

| | | | | | |
|---|---|---|---|---|---|
| Reverse | Flow rate (gfd) | 21.6 | 22.9 | 25.8 | 22.6 |
| osmosis | Salt removal rate (%) | 99.42 | 99.58 | 99.73 | 97.27 |
| membrane | Flow rate reduction ratio after | 13.60 | 14.80 | 17.10 | 24.87 |
| | contamination (%) | | | | |
| | Flow rate reduction ratio after | 0.38 | 0.41 | 1.50 | 3.23 |
| | immersion in preservation solution (%) | | | | |
| | Salt removal reduction rate after | 5.97 | 6.38 | 14.19 | 19.21 |
| | exposure to chlorine (%) | | | | |

TABLE 3

| | | | | Comparative | Comparative | Comparative | Comparative |
|---|---|---|---|---|---|---|---|
| Classification | | | | Example 3 | Example 4 | Example 5 | Example 6 |
| Manufacturing | Antifouling | Primary amine | Type | Methyl amine | ETA | ETA | ETA |
| method | coating agent | compound | Wt. % | 0.1 | 11.0 | 0.1 | 0.1 |

| | | | | | |
|---|---|---|---|---|---|
| | Water (wt. %) | 99.9 | 89.0 | 99.9 | 99.9 |
| Protective | Weight ratio | 1:1.1 | 1:1.1 | 1:0.1 | 1:1.8 |
| coating solution | of PVA:GA | | | | |

| | | | | | |
|---|---|---|---|---|---|
| Reverse | Flow rate (gfd) | 12.8 | 17.1 | 24.9 | 15.1 |
| osmosis | Salt removal rate (%) | 97.18 | 99.02 | 99.68 | 99.13 |
| membrane | Flow rate reduction ratio after | 15.03 | 12.20 | 16.30 | 12.50 |
| | contamination (%) | | | | |
| | Flow rate reduction ratio after | 2.90 | 0.28 | 1.10 | 0.35 |
| | immersion in preservation solution (%) | | | | |
| | Salt removal reduction rate after | 17.45 | 4.11 | 9.73 | 5.87 |
| | exposure to chlorine (%) | | | | |

When Tables 1 to 3 are reviewed, it was found that the reverse osmosis membranes manufactured in Examples 1 to 6 had excellent flow rates and salt removal rates, and the durability was also excellent.

On the other hand, in the case of Comparative Example 1 without a protective coating layer, it was confirmed that the salt removal reduction rate after exposure to chlorine was high and the durability was poor, compared to Example 1 with a protective coating layer.

Further, in the case of Comparative Example 2 and Comparative Example 3 using methylamine as the antifouling coating agent, it was found that the durability was poor due to the high physical properties in the preservation solution and the high salt removal reduction rate after exposure to chlorine, and it was determined to be due to the fact that the fouling resistant coating layer and the protective coating layer were not cross-linked, as the primary amine compound including at least one of a hydroxyl group and an alkoxy group was not used.

Further, in the case of Comparative Example 4 in which the amount of the primary amine compound was more than 10 wt. %, it was confirmed that the permeate flow rate was remarkably reduced, compared to Example 3 in which the amount of the primary amine compound was 10 wt. %.

Further, in the case of Comparative Example 5 in which the weight ratio of glutaraldehyde (GA) in the protective coating solution was less than 0.3, it was found that the durability of the separation membrane was poor due to the high physical properties in the preservation solution and the high salt removal reduction rate after exposure to chlorine, compared to Example 4 in which the weight ratio was 0.3.

Further, in the case of Comparative Example 6 in which the weight ratio of glutaraldehyde (GA) in the protective coating solution was more than 1.5, it was confirmed that the flow rate was remarkably reduced, compared to Example 5 in which the weight ratio was 1.5.

Although an embodiment of the present invention has been described above, the spirit of the present invention is not limited to the exemplary embodiment presented herein, and those skilled in the art who understand the spirit of the present invention may easily suggest other exemplary embodiments by modifying, changing, deleting or adding components within the scope of the same spirit, but this will also be said to fall within the scope of the present invention.

1. A polyamide reverse osmosis membrane having excellent durability and antifouling properties, comprising:
a porous support;
a polymer support layer which is formed on at least one surface of the porous support;
a polyamide layer which is formed on the polymer support layer;
a fouling resistant layer which is formed on the polyamide layer; and
a protective coating layer which is formed by cross-linking with a fouling resistant layer on the fouling resistant layer,
wherein the fouling resistant layer comprises a reaction product obtained by reacting a primary amine compound comprising at least one of a hydroxy group and an alkoxy group; and a polyfunctional acid halide compound.

2. The polyamide reverse osmosis membrane of claim 1, wherein the protective coating layer comprises a cross-linked product of polyvinyl alcohol and glutaraldehyde.

3. The polyamide reverse osmosis membrane of claim 1, wherein the polyamide layer comprises a reaction product obtained by reacting an amine compound and a polyfunctional acid halide compound.

4. The polyamide reverse osmosis membrane of claim 1, wherein when the reverse osmosis membrane is operated for 1 hour at a temperature of 25° C. and a pressure of 150 psi under the conditions of an aqueous solution comprising 1,500 ppm of sodium chloride (NaCl), the flow rate is 18.0 gfd or more.

5. The polyamide reverse osmosis membrane of claim 1, wherein when the flow rate is measured after the reverse osmosis membrane is circulated in raw water comprising 1,500 ppm of sodium chloride (NaCl) by further adding 50 ppm of dry milk, which is an organic contaminant, for 2 hours at a pressure of 150 psi to contaminate the membrane, the ratio of the reduced flow rate compared to the initial flow rate is less than 20%.

6. The polyamide reverse osmosis membrane of claim 1, wherein the reverse osmosis membrane has a salt removal reduction rate of less than 13.0% after exposure to chlorine as measured by Relationship Formula 1 below:
Salt removal reduction rate (%)=|Initial salt removal rate (%)−Salt removal rate after exposure to chlorine (%)|/(Initial salt removal rate (%))×100%, [Relationship Formula 1]
wherein in Relationship Formula 1 above, the ‘initial salt removal rate’ refers to the salt removal rate measured by operating the polyamide reverse osmosis membrane at a pressure of 150 psi under the conditions of raw water comprising NaCl at a concentration of 1,500 ppm, and the ‘salt removal rate after exposure to chlorine’ refers to the salt removal rate measured when the polyamide osmosis membrane is operated for 6 hours under the conditions of an aqueous solution comprising 1,500 ppm NaCl and 1,000 ppm NaOCl.

7. A method for manufacturing a polyamide reverse osmosis membrane having excellent durability and antifouling properties, comprising the steps of:
forming a polymer support layer by applying and drying a polymer solution on the surface of a porous support;
forming a polyamide layer on the surface of the polymer support layer;
forming a fouling resistant layer by coating an antifouling coating agent on the surface of the polyamide layer; and
forming a protective coating layer by coating a protective coating solution on the surface of the fouling resistant layer.

8. The method of claim 7, wherein the polymer solution comprises a polymer compound and a solvent, and
wherein the polymer compound comprises at least one selected from polysulfone-based polymers, polyethersulfone-based polymers, polyamide-based polymers, polyimide-based polymers, polyester-based polymers, olefin-based polymers, polyvinylidene fluoride and polyacrylonitrile.

9. The method of claim 7, wherein the antifouling coating agent comprises 0.001 to 10 wt. % of a primary amine compound comprising at least one of a hydroxy group and an alkoxy group; and a residual amount of solvent.

10. The method of claim 7, wherein the protective coating layer comprises a cross-linked product in which polyvinyl alcohol and glutaraldehyde are cross-linked at a weight ratio of 1:0.3 to 1:1.5.
